(19) United States
(12) Patent Application Publication
(10) Pub. No.: US 2004/0193642 A1
(43) Pub. Date: Sep. 30, 2004

(54) Apparatus and method for processing digital music files

(76) Inventors: Paul G. Allen, Seattle, WA (US); Timothy R. Perkis, Albany, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/401,502

(22) Filed: Mar. 26, 2003

(51) Int. Cl. G06F 17/00

(52) U.S. Cl. 707/104.1

(57) ABSTRACT

An apparatus and method to process music files is described. In particular, a computer-readable medium is provided. The computer-readable medium comprises an import module configured to determine whether a candidate music file corresponds to any of a plurality of music files that are incorporated in a database by comparing a digital signature of the candidate music file with digital signatures of the plurality of music files. The import module is configured to incorporate the candidate music file in the database based on determining that the candidate music file does not correspond to any of the plurality of music files.

### BRIEF DESCRIPTION OF THE INVENTION

The present invention relates generally to digital music files. More particularly, the present invention relates to processing digital music files to facilitate search and retrieval of desired audio content.

### BACKGROUND OF THE INVENTION

A digital music file includes audio content. In some instances, a digital music file includes audio content relating to a music performance using one or more percussion instruments and can be referred to as a percussion music file. A percussion instrument typically refers to a musical instrument for which a sound can be produced by striking or shaking a portion of the musical instrument. Examples of percussion instruments include drums, cymbals, castanets, and so forth.

Digital music files are rapidly gaining popularity among computer users. In particular, percussion music files, such as, for example, drum loops, drum fills, and drum hits, are increasingly used to produce musical compositions. Due to increasing availability of digital music files, search and retrieval of desired digital music files can be tedious and time-consuming.

Attempts have been made to organize digital music files using databases. While providing some benefits associated with use of a database, previous attempts generally suffer from one or more shortcomings. For instance, previous attempts typically lack a mechanism to adequately identify digital music files based on their audio content. As a result, multiple digital music files having the same audio content are often incorporated in a database, which unnecessarily reduces available storage and leads to inefficiencies during a search and retrieval process. Moreover, previous attempts sometimes fail to characterize digital music files using attributes that are intuitively meaningful to a user to facilitate search and retrieval of desired digital music files. Particularly when considering percussion music files, previous attempts typically fail to employ attributes that are intuitively meaningful to a user and are tailored for audio content of such percussion music files.

It is against this background that a need arose to develop the apparatus and method described herein.

### SUMMARY OF THE INVENTION

In one innovative aspect, the present invention relates to a computer-readable medium. In one embodiment, the computer-readable medium comprises an import module configured to determine whether a candidate music file corresponds to any of a plurality of music files that are incorporated in a database by comparing a digital signature of the candidate music file with digital signatures of the plurality of music files. The import module is configured to incorporate the candidate music file in the database based on determining that the candidate music file does not correspond to any of the plurality of music files.

In another embodiment, the computer-readable medium contains a set of instructions that when executed cause a processing system to perform a method. The method comprises indicating a plurality of percussion music attributes and receiving a user-specified selection of a percussion instrument sound type attribute from the plurality of percussion music attributes. The method also comprises indicating a set of percussion instrument sound types associated with the percussion instrument sound type attribute and receiving a user-specified selection of a first percussion instrument sound type from the set of percussion instrument sound types. The method further comprises producing a first search query based on the first percussion instrument sound type and indicating a plurality of percussion music files responsive to the first search query.

In another innovative aspect, the present invention relates to a method of processing music files. In one embodiment, the method comprises determining whether a candidate music file corresponds to any of a plurality of music files that are incorporated in a database by comparing a digital signature of said candidate music file with digital signatures of said plurality of music files. The method also comprises incorporating said candidate music file in said database based on determining that said candidate music file does not correspond to any of said plurality of music files.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a computer that can be operated in accordance with an embodiment of the invention.

FIG. 2 illustrates a flow chart for processing percussion music files in accordance with an embodiment of the invention.

FIG. 3 illustrates an example of a user-interface screen that can be provided by an import module, according to an embodiment of the invention.

FIG. 4 illustrates another example of a user-interface screen that can be provided by an import module, according to an embodiment of the invention.

FIG. 5 illustrates a further example of a user-interface screen that can be provided by an import module, according to an embodiment of the invention.

FIG. 6 illustrates an example of a user-interface screen that can be provided by a search module, according to an embodiment of the invention.

FIG. 7 illustrates another example of a user-interface screen that can be provided by a search module, according to an embodiment of the invention.

FIG. 8 illustrates a further example of a user-interface screen that can be provided by a search module, according to an embodiment of the invention.

FIG. 9 illustrates yet a further example of a user-interface screen that can be provided by a search module, according to an embodiment of the invention.

FIG. 10 illustrates an example of a user-interface screen that can be provided by an edit module, according to an embodiment of the invention.

### DETAILED DESCRIPTION

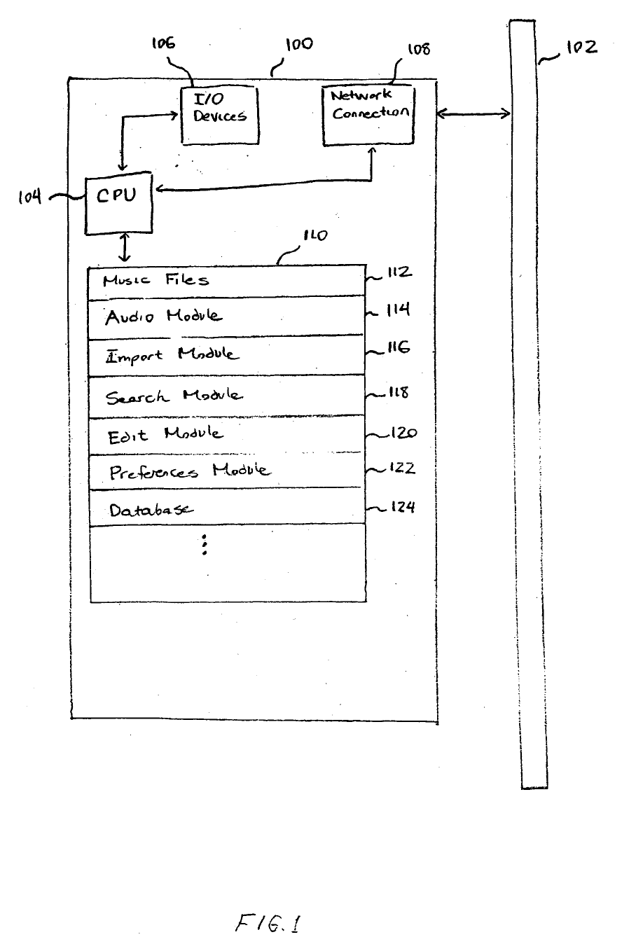

FIG. 1 illustrates a computer 100 that can be operated in accordance with an embodiment of the invention. The computer 100 may be a server computer, including conventional server computer components, or a client computer, including conventional client computer components. The computer 100 can be connected to a network 102 using any wire or wireless transmission channel. As shown in FIG. 1, the computer 100 includes a Central Processing Unit (“CPU”) 104 that is connected to a set (i.e., one or more) of input/output devices 106 (e.g., keyboard, mouse, video monitor, printer, speaker, and so forth), a network connection device 108, and a memory 110.

The memory 110 stores a set of digital music files 112 that can include audio content. For ease of discussion, a digital music file will be referred to below as a music file. As shown in FIG. 1, the memory 110 also stores an audio module 114. The audio module 114 is configured to produce an audio output based on audio content of one or more music files of the set of music files 112. For certain applications, the audio module 114 can also be configured to perform audio processing functions (e.g., editing, cutting, and mixing) to produce a musical composition based on one or more music files of the set of music files 112.

In the present embodiment of the invention, the memory 110 stores a set of computer programs that implement the processing described herein. In particular, the memory 110 stores an import module 116, a search module 118, an edit module 120, and a preferences module 122. The various modules 116, 118, 120, and 122 can be used to process the set of music files 112 to facilitate search and retrieval of one or more music files of the set of music files 112. In the present embodiment of the invention, the various modules 116, 118, 120, and 122 can operate in conjunction with a database 124, which can organize data associated with the set of music files 112.

The import module 116 is configured to incorporate the set of music files 112 in the database 124. A music file to be incorporated in the database 124 may be referred to as a candidate music file. In the present embodiment of the invention, the import module 116 can determine whether a candidate music file corresponds to any of various music files that are incorporated in the database 124. In particular, the import module 116 can compare a digital signature of the candidate music file with digital signatures of the various music files to determine whether the candidate music file corresponds to any of the various music files. A digital signature of a music file typically refers to data that serve to identify the music file. More particularly, a digital signature of a music file may refer to data that serve to substantially uniquely identify the music file based on audio content of the music file. For certain applications, the import module 116 can produce a digital signature of a candidate music file by applying a hash function to the candidate music file. An example of a hash function that can be used is Message Digest 5 (“MD5”), which can produce a digital signature in the form of a 128-bit message digest. Based on determining that a candidate music file does not correspond to any of various music files that are incorporated in the database 124, the import module 116 can incorporate the candidate music file in the database 124. Otherwise, the import module 116 can indicate that the candidate music file is already incorporated in the database 124. As a result, the import module 116 can serve to prevent multiple music files having the same audio content from being incorporated in the database 124.

In the present embodiment of the invention, the import module 116 can incorporate a candidate music file in the database 124 by incorporating a set of attribute values of the candidate music file in the database 124. In general, an attribute of a music file refers to a particular property of the music file, and a value of the attribute (or attribute value) refers to a particular instance of the attribute. Desirably, the present embodiment of the invention employs attributes that are intuitively meaningful to a user to facilitate search and retrieval of desired music files. For instance, an attribute of a music file may refer to a particular property associated with audio content of the music file and may be referred to as a music attribute. A music attribute can correspond to, for example, a music performer, a music collection, a music record name, a music performance name, a musical instrument sound type, a music style, a music rhythm, a music meter, a music duration, or a music tempo. As another example, an attribute of a music file may refer to a format, a size, a name, or a digital signature of the music file. In the present embodiment of the invention, the database 124 can organize or index attribute values of the set of music files 112 to facilitate a search for one or more music files having a particular set of attribute values.

Once the set of music files 112 is incorporated in the database 124, the search module 118 is configured to search for one or more music files of the set of music files 112. In the present embodiment of the invention, the search module 118 can produce a search query for the database 124 based on a set of attribute values and can indicate one or more music files that are responsive to the search query. In particular, the search module 118 can identify the set of attribute values in the database 124 and can correlate the set of attribute values with one or more music files having the set of attribute values. A music file that is indicated as responsive to the search query can be retrieved from the set of music files 112 for further processing using the audio module 114. Alternatively, or in conjunction, a music file that is indicated as responsive to the search query can be further processed using the edit module 120 as described below.

The edit module 120 is configured to modify one or more attribute values of one or more music files that are incorporated in the database 124. In particular, the edit module 120 can replace a set of attribute values of a music file with a different set of attribute values. Alternatively, or in conjunction, the edit module 120 can incorporate an additional set of attribute values of a music file in the database 124. In the present embodiment of the invention, the edit module 120 can also delete one or more music files from the database 124.

The preferences module 122 is configured to allow a user to specify a variety of options for processing one or more music files of the set of music files 112. In particular, the preferences module 122 can allow a user to specify a variety of processing options for one or more of the import module 116, the search module 118, and the edit module 120.

While the set of music files 112, the various modules 114, 116, 118, 120, and 122, and the database 124 are shown residing in the single computer 100, it should be recognized that such configuration is not required in all applications. For instance, one or more of the various modules 114, 116, 118, 120, and 122 or the database 124 may reside in a separate computer (not shown in FIG. 1) that is connected to the network 102. In addition, while not shown in FIG. 1, a database management system (e.g., a conventional database management system) may be provided to create the database 124 as well as to facilitate access to the database 124 using the import module 116, the search module 118, and the edit module 120. Moreover, while not shown in FIG. 1, an audio processing tool (e.g., a conventional audio processing tool such as Pro Tools system available from Digidesign, located in Daly City, Calif.) can be used instead of, or in conjunction with, the audio module 114 to produce audio output and perform a variety of audio processing functions based on audio content of one or more music files.

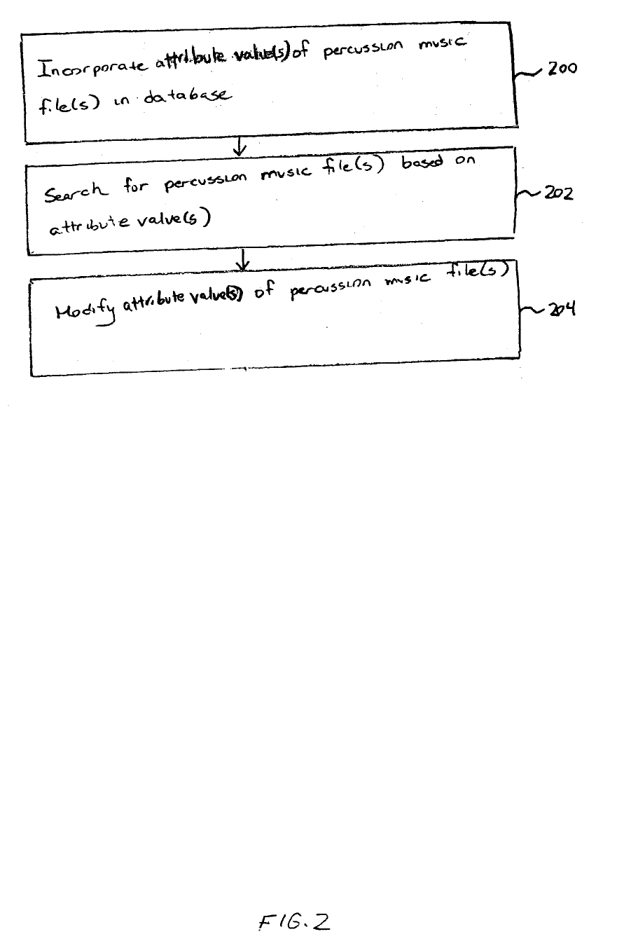

The foregoing discussion provides a general overview of an embodiment of the invention. Attention now turns to FIG. 2 that illustrates a flow chart for processing percussion music files in accordance with another embodiment of the invention.

The first processing operation shown in FIG. 2 is to incorporate one or more attribute values of one or more percussion music files in a database (e.g., the database 124) (block 200). In the present embodiment of the invention, the database can be a relational database that can include a set of tables. The set of tables can be defined with respect to a number of attributes of a percussion music file. For instance, the set of tables can be defined with respect to various percussion music attributes. The various percussion music attributes are desirably chosen to be intuitively meaningful to a user and can be tailored to characterize audio content of a percussion music file. The various percussion music attributes can correspond to, for example, a percussion music performer, a percussion music collection, a percussion music record name, a percussion music performance name, a percussion instrument sound type, a percussion music style, a percussion music rhythm, a percussion music meter, a percussion music duration, a percussion music tempo, and so forth. In the present embodiment of the invention, the set of tables can include various database fields, and a database field can be associated with a particular attribute.

In the present embodiment of the invention, an import module (e.g., the import module 116) can indicate various attributes that are used to define the database, and one or more values of one or more attributes can be specified for a percussion music file to be incorporated in the database. For certain applications, the import module can provide a numeric or text entry field to allow a user to specify an attribute value of a percussion music file. Alternatively, or in conjunction, the import module can indicate a set of attribute values using, for example, a pull-down menu. The set of attribute values can correspond to distinct attribute values included in a database field associated with a particular attribute, and one or more attribute values of the set of attribute values can be selected for a percussion music file. Once one or more attribute values are specified for a percussion music file, the import module can direct creation of one or more database records in the set of tables for the percussion music file, which one or more database records can include the one or more attribute values.

For certain applications, the import module can automatically derive one or more attribute values of a percussion music file, and the one or more attributes values can be incorporated in the database. For instance, one or more attribute values can be automatically derived based on audio content of a percussion music file or based on a format, a size, or a name of the percussion music file.

With reference to FIG. 2, the second processing operation shown is to search for one or more percussion music files based on one or more attribute values (block 202). In the present embodiment of the invention, a search module (e.g., the search module 118) can indicate various attributes that are used to define the database, and one or more values of one or more attributes can be specified for a search of the database. For certain applications, the search module can provide a numeric or text entry field to allow a user to specify an attribute value for a search of the database. Alternatively, or in conjunction, the search module can indicate a set of attribute values using, for example, a pull-down menu. As discussed previously, the set of attribute values can correspond to distinct attribute values included in a database field associated with an attribute, and one or more attribute values of the set of attribute values can be selected for a search of the database. Once one or more attribute values are specified, the search module can direct creation of a search query for the database based on the one or more attribute values. In particular, the search module can direct creation of a search query to identify one or more database records for one or more percussion music files, which one or more database records can include the one or more attribute values.

The third processing operation shown in FIG. 2 is to modify one or more attribute values of one or more percussion music files that are incorporated in the database (block 204). In the present embodiment of the invention, an edit module (e.g., the edit module 120) can indicate various attributes that are used to define the database, and one or more values of one or more attributes can be specified for a percussion music file that is incorporated in the database. A different set of attribute values can be specified to replace a set of attribute values previously incorporated in the database for a percussion music file. Alternatively, or in conjunction, an additional set of attribute values can be specified for a percussion music file. For certain applications, the edit module can provide a numeric or text entry field to allow a user to specify an attribute value of a percussion music file. Alternatively, or in conjunction, the edit module can indicate a set of attribute values using, for example, a pull-down menu. As discussed previously, the set of attribute values can correspond to distinct attribute values included in a database field associated with an attribute, and one or more attribute values of the set of attribute values can be selected for a percussion music file. Once one or more attribute values are specified, the edit module can direct updating of one or more database records in the set of tables based on the one or more attribute values.

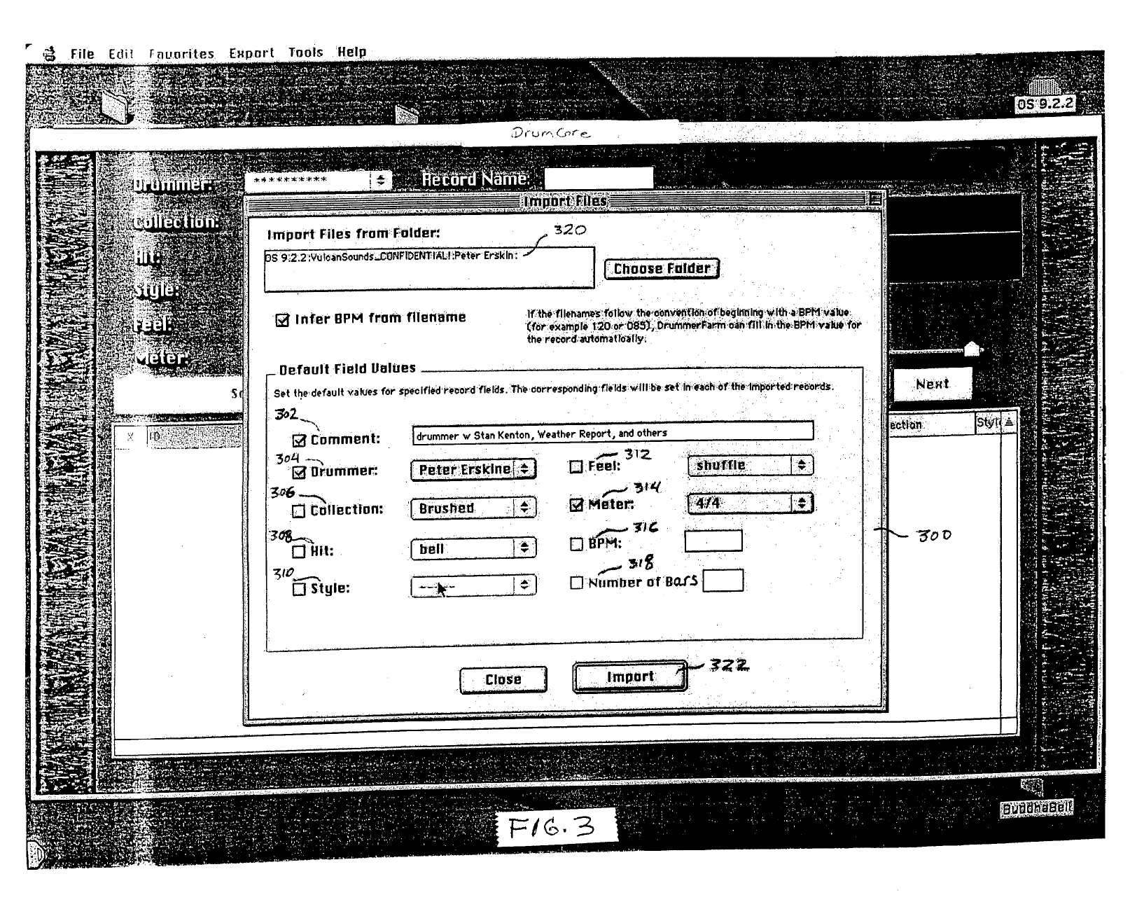

Turning next to FIG. 3 through FIG. 10, various examples of user-interface screens that can be provided to process percussion music files are shown, according to an embodiment of the invention.

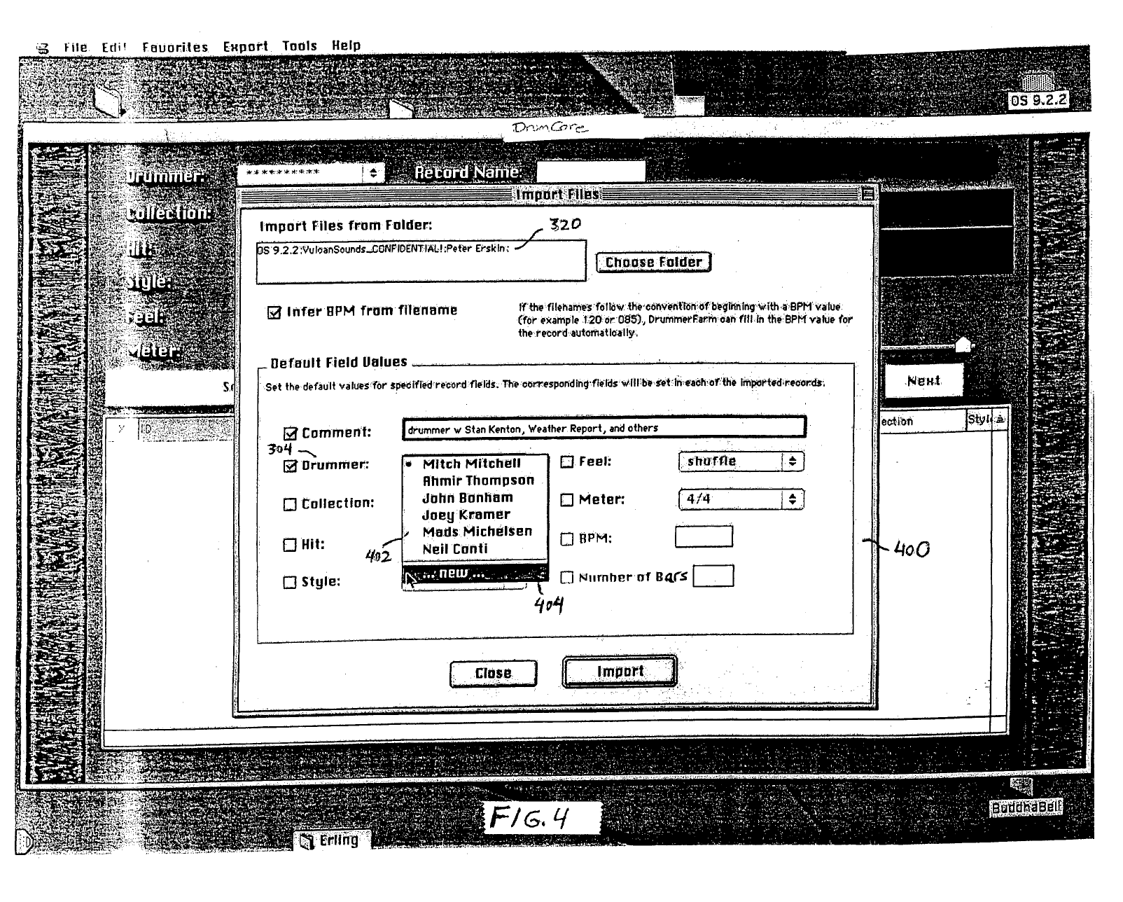

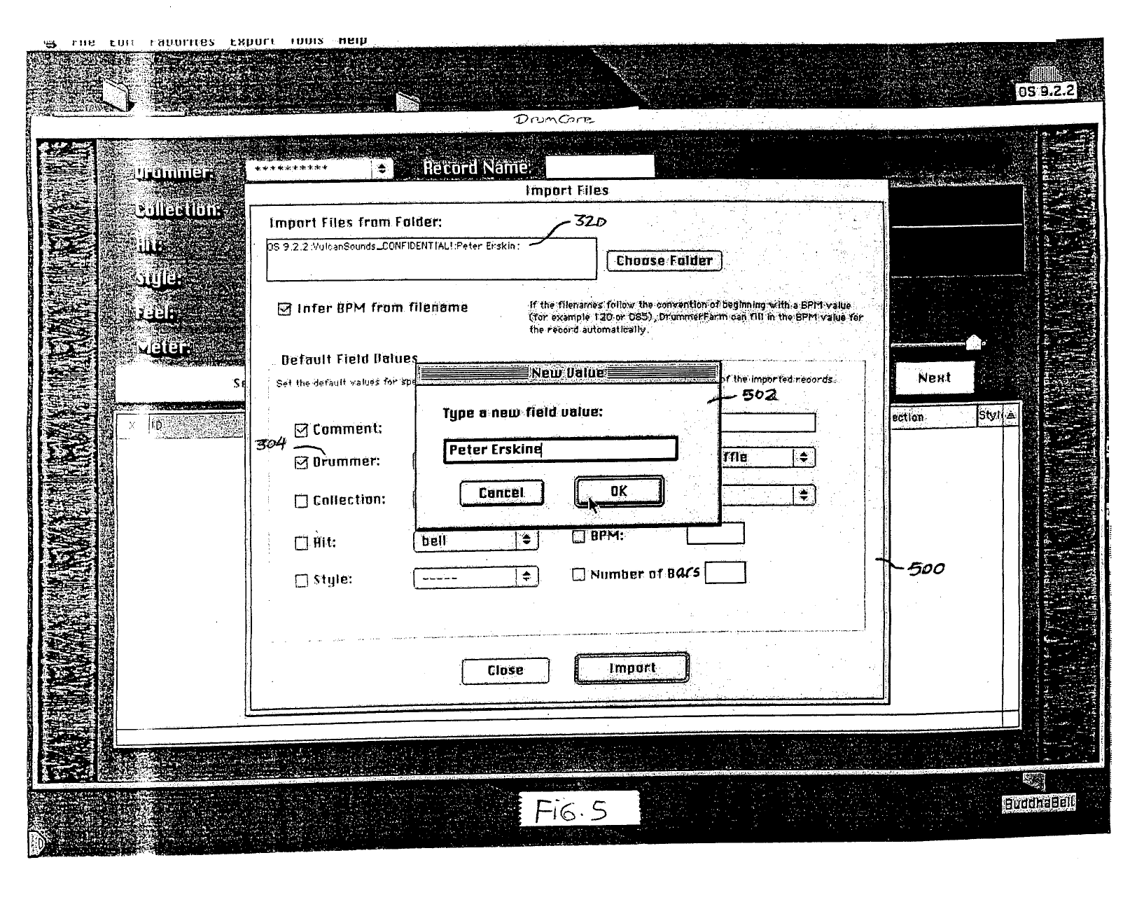

FIG. 3, FIG. 4, and FIG. 5 illustrate examples of user-interface screens that can be provided by an import module (e.g., the import module 116). With reference to FIG. 3, a user-interface screen 300 to incorporate a set of percussion music files 320 in a database (e.g., the database 124) is illustrated. As shown in FIG. 3, the user-interface screen 300 indicates various attributes 302, 304, 306, 308, 310, 312, 314, 316, and 318 that are used to define the database. The user-interface screen 300 allows a user to specify one or more values of one or more attributes for the set of percussion music files 320. In the present example, a particular attribute can be selected by, for example, a, mouse click or a keyboard selection, and a value of the attribute can be specified for the set of percussion music files 320. Once one or more attribute values have been specified for the set of percussion music files 320, an option 322 labeled as “Import” can be selected to incorporate the set of percussion music files 320 in the database.

As shown in FIG. 3, the attribute 302 labeled as “Comment” can be selected to specify a variety of user annotations to characterize the set of percussion music files 320. The attribute 304 labeled as “Drummer” can be selected to specify a particular percussion music performer. For example, selecting the attribute 304 allows a user to specify “Peter Erskine” as the percussion music performer. As shown in FIG. 3, the attribute 306 labeled as “Collection” can be selected to specify a particular percussion music collection from which the set of percussion music files 320 is derived. The attribute 308 labeled as “Hit” can be selected to specify a particular percussion instrument sound type. Examples of percussion instrument sound types that can be specified include bell, crash, flam, snare, and rimshot. The attribute 310 labeled as “Style” can be selected to specify a particular percussion music style. Examples of percussion music styles that can be specified include rock, hip-hop, soft rock, funk, country-western, rhythm & blues, Jazz, and world music. With reference to FIG. 3, the attribute 312 labeled as “Feel” can be selected to specify a particular percussion music rhythm. Examples of percussion music rhythms that can be specified include shuffle, straight, straight 8^{th}, straight 16^{th}, swing, swing 8^{th}, and swing 16^{th}. The attribute 314 labeled as “Meter” can be selected to specify a particular percussion music meter. Examples of percussion music meters that can be specified include 2/4, 3/4, 4/4, 5/4, 6/4, 3/8, 5/8, 10/8, and 12/8. The attribute 316 labeled as “BPM” can be selected to specify a particular percussion music tempo, which can be expressed as a number of beats per minute. And, the attribute 318 labeled as “Number of Bars” can be selected to specify a particular percussion music duration, which can be expressed as a number of bars.

In the present example, numeric or text entry fields allow values of the attributes 302, 316, and 318 to be specified, while pull-down menus allow values of the attributes 304, 306, 308, 310, 312, and 314 to be specified. FIG. 4 illustrates a user-interface screen 400 that indicates a pull-down menu 402 for the attribute 304 discussed in connection with FIG. 3. Referring to FIG. 4, the pull-down menu 402 indicates a set of attribute values, and a user can select a particular attribute value of the set of attribute values for the set of percussion music files 320. The set of attribute values indicated in the pull-down menu 402 can correspond to distinct attribute values included in a database field associated with the attribute 304. In the present example, the set of attribute values corresponds to a set of percussion music performers. As shown in FIG. 4, the pull-down menu 402 also indicates an option 404 labeled as “new” that can be selected to specify a new value of the attribute 304 for the set of percussion music files 320.

FIG. 5 illustrates a user-interface screen 500 that can be provided in response to a user selecting the option 404 discussed in connection with FIG. 4. As shown in FIG. 5, a pop-up window 502 labeled as “New Value” can be provided to specify a new value of the attribute 304. In the present example, a user can specify “Peter Erskine” as a percussion music performer for the set of percussion music files 320. Once a new attribute value is specified, the new attribute value can be incorporated in a database field associated with an attribute. In particular, the new attribute value can be incorporated in a set of attribute values associated with the attribute to produce a modified set of attribute values associated with the attribute. The modified set of attribute values can be subsequently indicated in a pull-down menu for the attribute to allow a user to select the new attribute value in connection with processing one or more percussion music files.

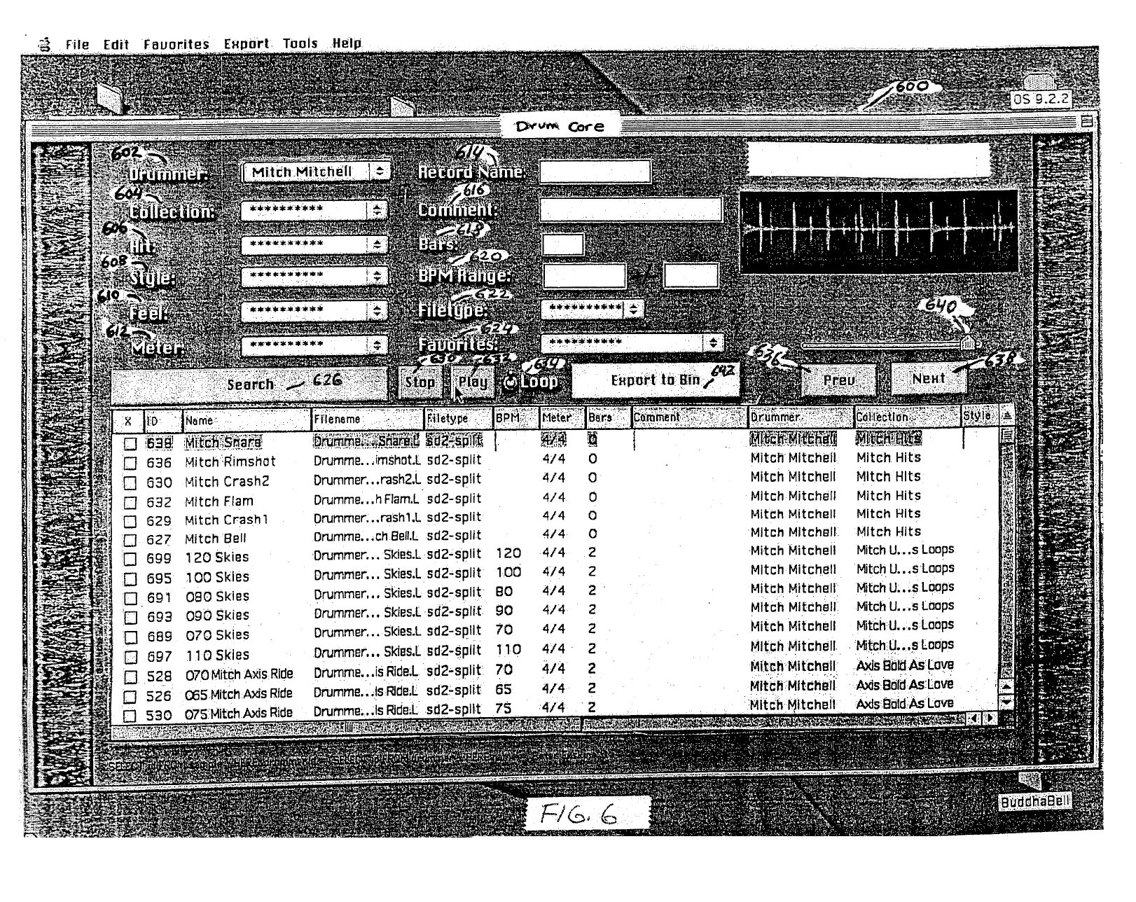

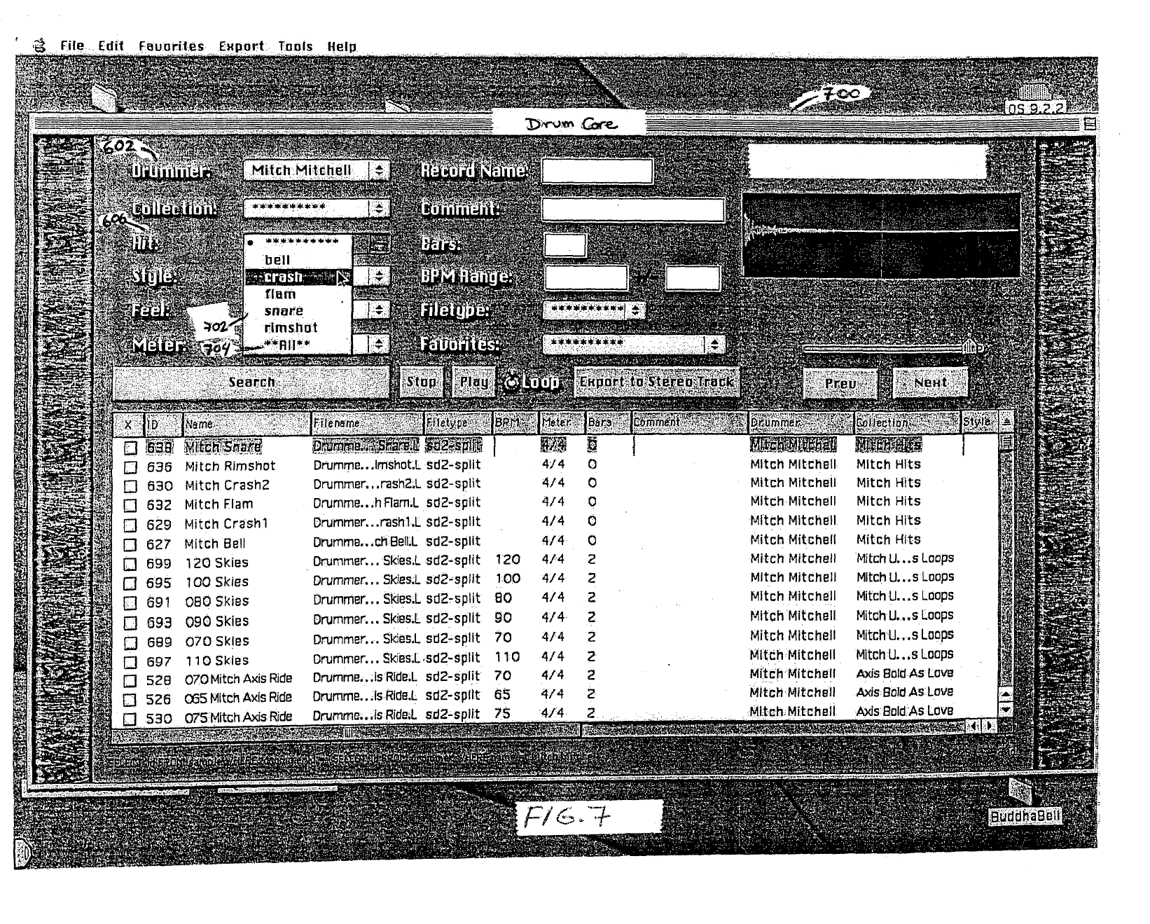

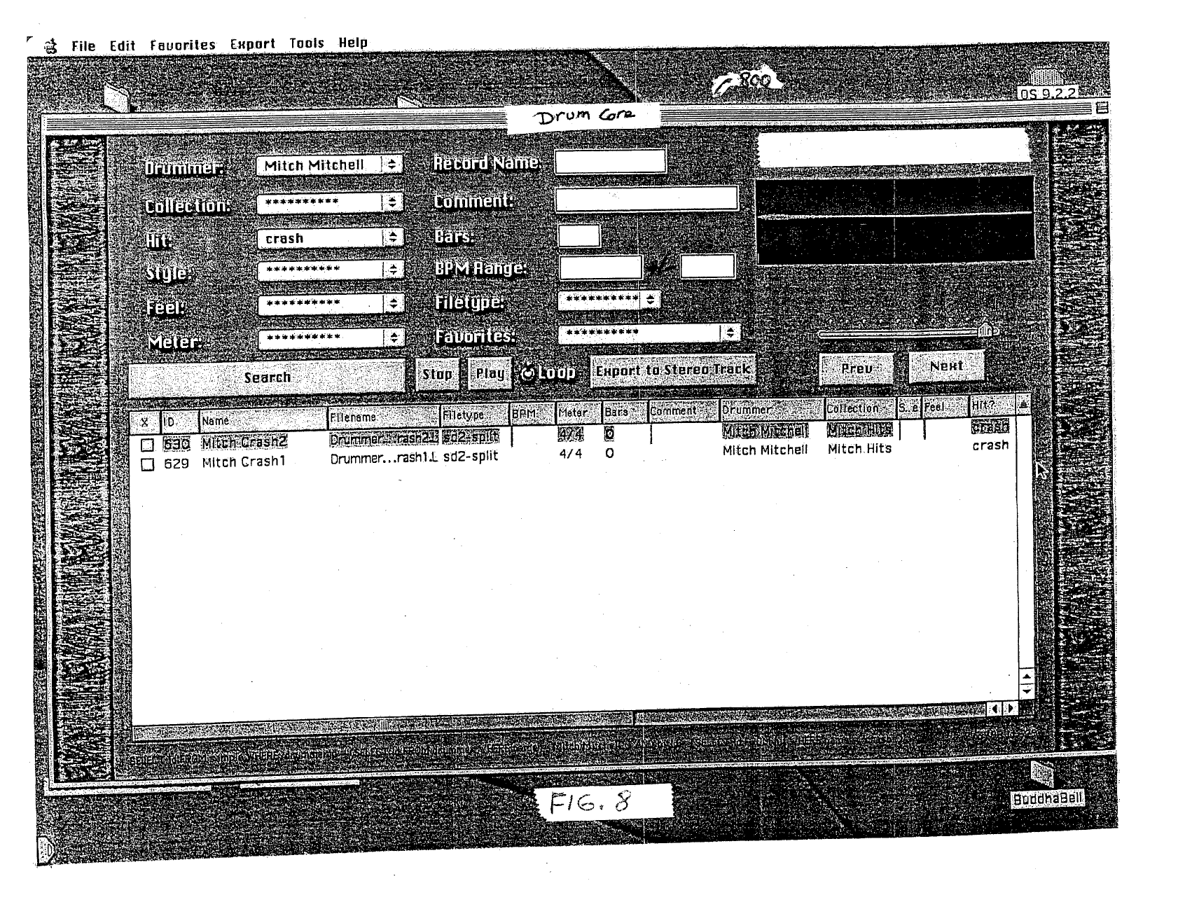

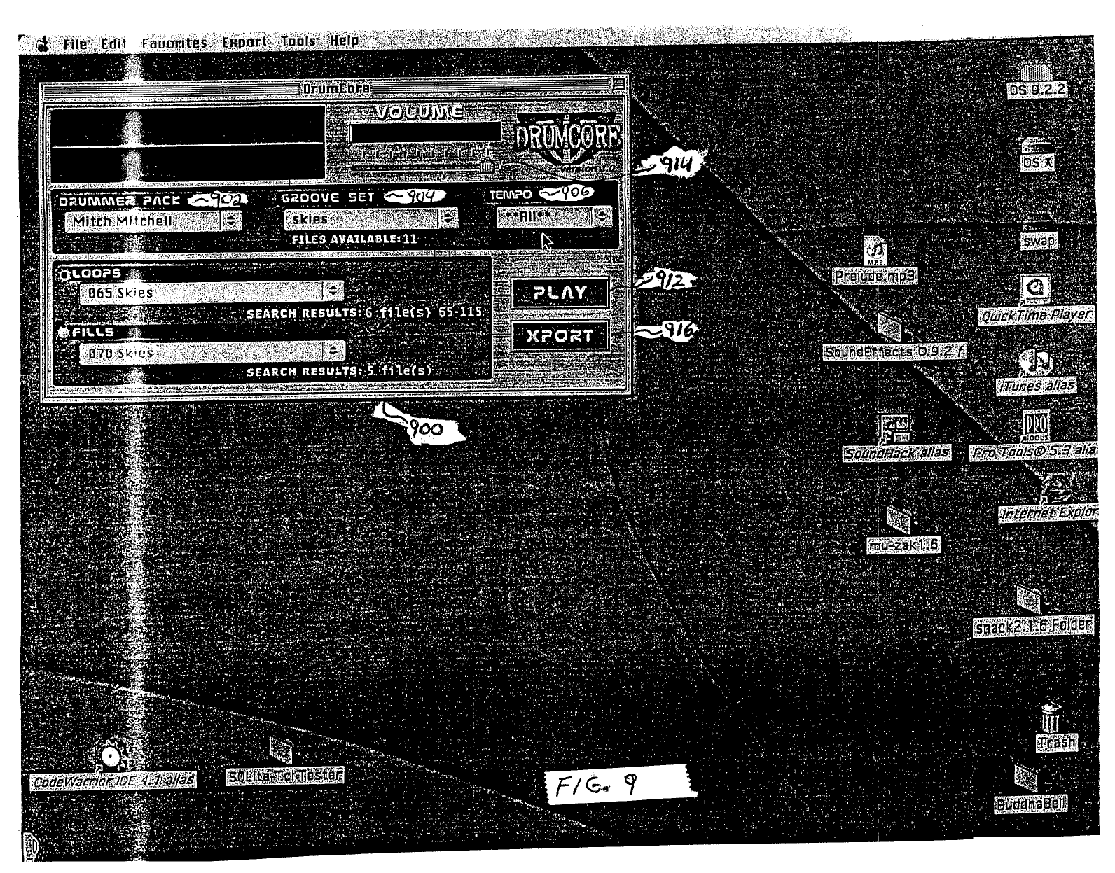

With reference to FIG. 6, FIG. 7, FIG. 8, and FIG. 9, various examples of user-interface screens that can be provided by a search module (e.g., the search module 118) are illustrated. FIG. 6 illustrates a user-interface screen 600 to search for one or more percussion music files that are incorporated in a database (e.g., the database 124). As shown in FIG. 6, the user-interface screen 600 indicates various attributes 602, 604, 606, 608, 610, 612, 614, 616, 618, 620, 622, and 624 that are used to define the database. The user-interface screen 600 allows a user to specify one or more values of one or more attributes for a search of the database. In the present example, a particular attribute can be selected by, for example, a mouse click or a keyboard selection, and a value of the attribute can be specified for a search of the database. Once one or more attribute values have been specified, an option 626 labeled as “Search” can be selected to produce a search query for the database based on the one or more attribute values.

The attributes 602, 604, 606, 608, 610, 612, 616, and 618 can be defined as previously discussed in connection with FIG. 3. Referring to FIG. 6, the attribute 614 labeled as “Record Name” can be selected to specify a particular file name. The attribute 620 labeled as “BPM Range” can be selected to specify a particular percussion music tempo, which can be expressed as a range of number of beats per minute. The attribute 622 labeled as “Filetype” can be selected to specify a particular file format. Examples of file formats that can be specified include sd2, aiff, wav, au, and MIDI. And, the attribute 624 labeled as “Favorites” can be selected to specify membership in a particular favorite set of percussion music files.

In the present example, numeric or text entry fields allow values of the attributes 614, 616, 618, and 620 to be specified, while pull-down menus allow values of the attributes 602, 604, 606, 608, 610, 612, 622, and 624 to be specified. As shown in FIG. 6, the attribute 602 labeled as “Drummer” can be selected to specify a particular percussion music performer. In particular, selecting the attribute 602 allows a user to specify “Mitch Mitchell” as the percussion music performer using a pull-down menu. A search query for the database can be produced based on the specified value of the attribute 602. As shown in FIG. 6, various percussion music files are indicated as being responsive to the search query.

One or more of the percussion music files can be selected for further processing. As shown in FIG. 6, the user-interface screen 600 indicates various options 630, 632, 634, 636, 638, and 640 that can be selected to direct an audio module (e.g., the audio module 114) to produce an audio output based on one or more of the percussion music files. In addition, the user-interface screen 600 indicates an option 642 that can be selected to export one or more of the percussion music files to an audio processing tool. Moreover, one or more of the percussion music files can be incorporated in a favorite set of percussion music files. In the present example, various favorite sets of percussion music files can be defined, and one or more of the percussion music files can be incorporated in a selected one of the various favorite sets of percussion music files.

If desired, various attribute values can be specified, and a search query for the database can be produced based on the various attribute values. FIG. 7 illustrates a user-interface screen 700 that indicates a pull-down menu 702 for the attribute 606 discussed in connection with FIG. 6. In the present example, the pull-down menu 702 indicates a set of attribute values, and a user can select a particular attribute value of the set of attribute values for a search of the database. The set of attribute values indicated in the pull-down menu 702 can correspond to distinct attribute values included in a database field associated with the attribute 606. In the present example, the set of attribute values corresponds to a set of percussion instrument sound types. As shown in FIG. 7, the pull-down menu 702 also indicates an option 704 labeled as “All” that can be selected to specify all attribute values of the set of attribute values. Referring to FIG. 7, a search query for the database can be produced based on the specified value of the attribute 602 (e.g., Mitch Mitchell) and the specified value of the attribute 606 (e.g., crash).

FIG. 8 illustrates a user-interface screen 800 that indicates various percussion music files as being responsive to the search query. In the present example, the various percussion music files can be a subset of the percussion music files indicated in FIG. 6 and FIG. 7.

FIG. 9 illustrates a user-interface screen 900 to search for one or more percussion music files that are incorporated in a database (e.g., the database 124). The user-interface screen 900 allows a user to specify values of attributes 902, 904, and 906 for a search of the database. In the present example, a particular attribute can be selected by, for example, a mouse click or a keyboard selection, and a value of the attribute can be specified for a search of the database.

As shown in FIG. 9, the attribute 902 labeled as “Drummer Pack” can be selected to specify a particular percussion music performer. The attribute 904 labeled as “Groove Set” can be selected to specify a particular percussion music performance name. And, the attribute 906 labeled as “Tempo” can be selected to specify a particular percussion music tempo. In the present example, pull-down menus can be provided to allow a user to specify values of the attributes 902, 904, and 906. In particular, a pull-down menu can indicate a set of attribute values, and a user can select a particular attribute value of the set of attribute values for a search of the database. In the present example, once a value of a first attribute (e.g., the attribute 902) is specified, a pull-down menu for a second attribute (e.g., the attribute 904) can indicate a set of attribute values that can depend on the specified value of the first attribute. Similarly, a pull-down menu for a third attribute (e.g., the attribute 906) can indicate a set of attribute values that can depend on the specified values of the first and second attributes. For instance, with reference to FIG. 9, once a value (e.g., Mitch Mitchell) of the attribute 902 is specified, a first search query for the database can be automatically produced based on the specified value of the attribute 902 to identify various percussion music files that are responsive to the first search query. A pull-down menu for the attribute 904 can indicate a set of attribute values that can correspond to distinct values of the attribute 904 for the various percussion music files. Once a value (e.g., skies) of the attribute 904 is specified, a second search query for the database can be automatically produced based on the specified values of the attributes 902 and 904 to identify a subset of the various percussion music files that is responsive to the second search query.

As shown in FIG. 9, various percussion music files are indicated as being responsive to a search query. Here, the user-interface 900 indicates a first subset of the various percussion music files as corresponding to loops (e.g., drum loops) and a second subset of the various percussion music files as corresponding to fills (e.g., drum fills). One or more of the various percussion music files can be selected for further processing. As shown in FIG. 9, the user-interface screen 900 indicates options 912 and 914 that can be selected to direct an audio module (e.g., the audio module 114) to produce an audio output based on one or more of the various percussion music files. In addition, the user-interface screen 900 indicates an option 916 that can be selected to export one or more of the various percussion music files to an audio processing tool.

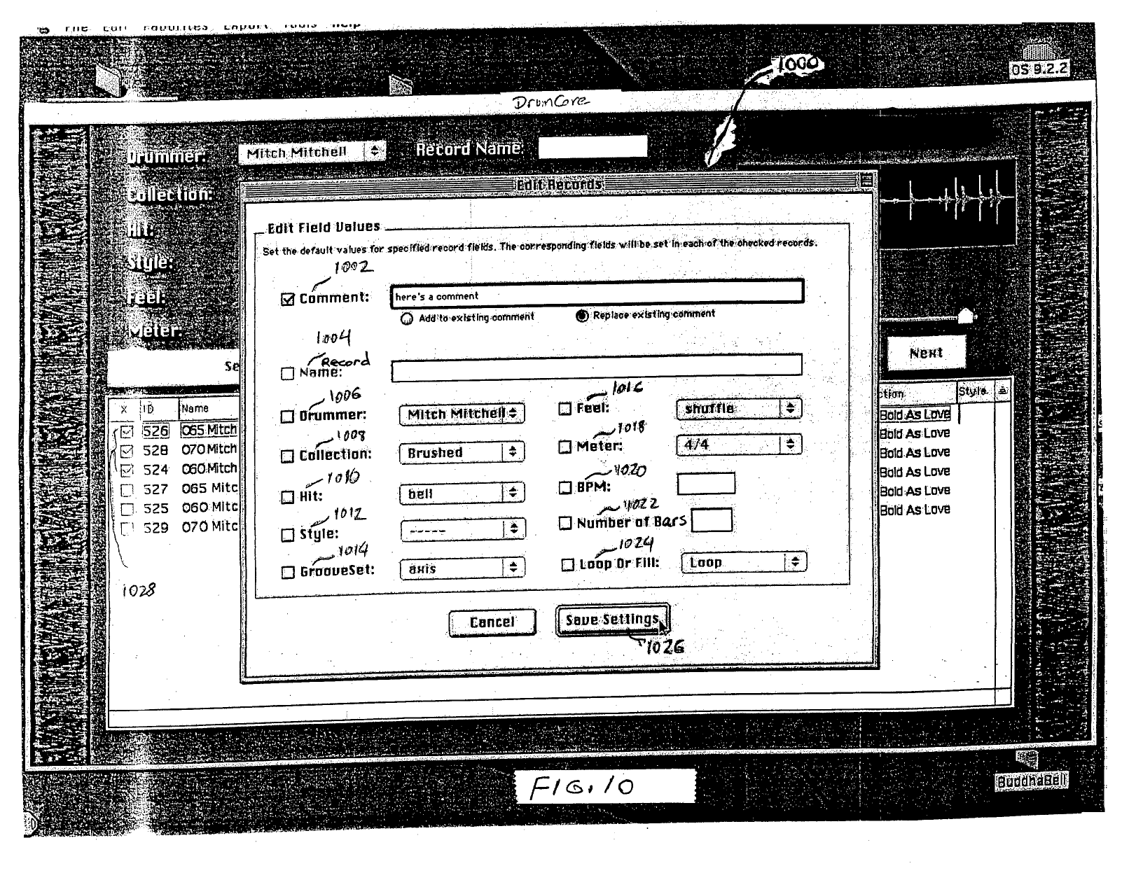

FIG. 10 illustrates an example of a user-interface screen 1000 that can be provided by an edit module (e.g., the edit module 120). In particular, the user-interface screen 1000 allows a user to modify one or more attribute values of a set of percussion music files 1028 incorporated in a database (e.g., the database 124). In the present example, the set of percussion music files 1028 can be selected from various percussion music files that are identified using a search module (e.g., the search module 118). As shown in FIG. 10, the user-interface screen 1000 indicates various attributes 1002, 1004, 1006, 1008, 1010, 1012, 1014, 1016, 1018, 1020, 1022, and 1024 that are used to define the database. The user-interface screen 1000 allows a user to specify one or more values of one or more attributes for updating the database. In the present example, a particular attribute can be selected by, for example, a mouse click or a keyboard selection, and a value of the attribute can be specified for updating the database. Once one or more attribute values have been specified, an option 1026 labeled as “Save Settings” can be selected to update the database based on the one or more attribute values.

With reference to FIG. 10, the attributes 1002, 1004, 1006, 1008, 1010, 1012, 1014, 1016, 1018, 1020, and 1022 can be defined as previously discussed in connection with FIG. 3, FIG. 6, and FIG. 9. Here, the attribute 1024 labeled as “Loop or Fill” can be selected to specify whether the set of percussion music files 1028 corresponds to a set of loops (e.g., a set of drum loops) or a set of fills (e.g., a set of drum fills). In the present example, values of the attributes 1002, 1004, 1020, and 1022 can be specified using numeric or text entry fields, while values of the attributes 1006, 1008, 1010, 1012, 1014, 1016, 1018, and 1024 can be specified using pull-down menus. If desired, one or more new values of one or more attributes can be specified. Once a new attribute value is specified, the new attribute value can be incorporated in a database field associated with an attribute. In particular, the new attribute value can be incorporated in a set of attribute values associated with the attribute to produce a modified set of attribute values associated with the attribute. The modified set of attribute values can be subsequently indicated in a pull-down menu for the attribute to allow a user to select the new attribute value in connection with processing one or more percussion music files.

It should be recognized that the specific embodiments of the invention discussed above are merely exemplary, and various other embodiments are encompassed by the present invention.

For instance, an embodiment of the invention may include a help system, including a wizard that provides assistance to users, for configuring a computer (e.g., the computer 100) and its various components.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher level code that are executed by a computer using an interpreter. For example, an embodiment of the invention may be implemented using Java, C++, or other object-oriented programming language and development tools.

Another embodiment of the invention may be implemented in hardwired circuitry in place of, or in combination with, machine-executable software instructions.

While the present invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process step or steps, to the objective, spirit and scope of the present invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

What is claimed is:

1. A computer-readable medium, comprising:
an import module configured to determine whether a candidate music file corresponds to any of a plurality of music files that are incorporated in a database by comparing a digital signature of said candidate music file with digital signatures of said plurality of music files, said import module being configured to incorporate said candidate music file in said database based on determining that said candidate music file does not correspond to any of said plurality of music files.

2. The computer-readable medium of claim 1, wherein said import module is configured to produce said digital signature of said candidate music file by applying a hash function to said candidate music file.

3. The computer-readable medium of claim 1, wherein said import module is configured to incorporate said candidate music file in said database by incorporating a music attribute value of said candidate music file in said database.

4. The computer-readable medium of claim 3, further comprising:
a search module configured to produce a search query for said database based on said music attribute value of said candidate music file and to indicate said candidate music file as responsive to said search query.

5. The computer-readable medium of claim 3, further comprising:
an edit module configured to modify said music attribute value of said candidate music file in said database.

6. The computer-readable medium of claim 5, wherein said music attribute value of said candidate music file corresponds to a first music attribute value of said candidate music file, said edit module being configured to incorporate a second music attribute value of said candidate music file in said database.

7. A computer-readable medium, said computer-readable medium containing a set of instructions that when executed cause a processing system to perform a method comprising:
indicating a plurality of percussion music attributes;
receiving a user-specified selection of a percussion instrument sound type attribute from said plurality of percussion music attributes;
indicating a set of percussion instrument sound types associated with said percussion instrument sound type attribute;
receiving a user-specified selection of a first percussion instrument sound type from said set of percussion instrument sound types;
producing a first search query based on said first percussion instrument sound type; and
indicating a,plurality of percussion music files responsive to said first search query.

8. The computer-readable medium of claim 7, wherein said method further comprises:
receiving a user-specified selection of a percussion music file from said plurality of percussion music files; and
retrieving said percussion music file.

9. The computer-readable medium of claim 8, wherein said method further comprises:
producing an audio output based on said percussion music file.

10. The computer-readable medium of claim 7, wherein said method further comprises:
receiving a user-specified selection of a percussion music file from said plurality of percussion music files; and
incorporating said percussion music file in a favorite set of percussion music files.

11. The computer-readable medium of claim 7, wherein said method further comprises:
incorporating a second percussion instrument sound type of a percussion music file in said set of percussion instrument sound types to produce a modified set of percussion instrument sound types associated with said percussion instrument sound type attribute;
indicating said modified set of percussion instrument sound types; receiving a user-specified selection of said second percussion instrument sound type from said modified set of percussion instrument sound types;
producing a second search query based on said second percussion instrument sound type; and
indicating said percussion music file as responsive to said second search query.

12. The computer-readable medium of claim 7, wherein said first percussion instrument sound type corresponds to a first percussion music attribute value, and said method further comprises:
receiving a second percussion music attribute value based on user input,
wherein producing said first search query includes producing said first search query based on said first percussion music attribute value and said second percussion music attribute value.

13. The computer-readable medium of claim 12, wherein said second percussion music attribute value is associated with one of a percussion music performer, a percussion music collection, a percussion music style, a percussion music rhythm, a percussion music meter, a percussion music duration, and a percussion music tempo.

14. The computer-readable medium of claim 12, wherein said percussion instrument sound type attribute corresponds to a first percussion music attribute, said set of percussion instrument sound types corresponds to a first set of percussion music attribute values, and receiving said second percussion music attribute includes:
receiving a user-specified selection of a second percussion music attribute from said plurality of percussion music attributes;
indicating a second set of percussion music attribute values associated with said second percussion music attribute; and
receiving a user-specified selection of said second percussion music attribute value from said second set of percussion music attribute values.

15. A method of processing music files, comprising:
determining whether a candidate music file corresponds to any of a plurality of music files that are incorporated in a database by comparing a digital signature of said candidate music file with digital signatures of said plurality of music files; and
incorporating said candidate music file in said database based on determining that said candidate music file does not correspond to any of said plurality of music files.

16. The method of claim 15, further comprising:
producing said digital signature of said candidate music file by applying a hash function to said candidate music file.

17. The method of claim 15, wherein incorporating said candidate music file in said database includes:
incorporating a music attribute value of said candidate music file in said database.

18. The method of claim 17, further comprising:
producing a search query for said database based on said music attribute value of said candidate music file; and
indicating said candidate music file as responsive to said search query.

19. The method of claim 17, further comprising:
modifying said music attribute value of said candidate music file in said database.
